(19) United States
(12) Patent Application Publication
(10) Pub. No.: US 2007/0105996 A1
(43) Pub. Date: May 10, 2007

(54) Composition containing a hydroxyalkylurea and a polyolefin having a polar part

(75) Inventor: Jean-Thierry Simonnet, Cachan (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 11/511,320

(22) Filed: Aug. 29, 2006

Related U.S. Application Data
(60) Provisional application No. 60/712,425, filed on Aug. 31, 2005.

(30) Foreign Application Priority Data
Aug. 30, 2005 (FR) 05 52601

(51) Int. Cl. C08K 5/00

(52) U.S. Cl. 524/211

(57) ABSTRACT

The invention relates to a composition containing an aqueous phase dispersed in an oily phase; at least one compound of invention formula (I): 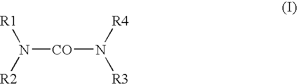 their salts and their solvates; and at least one polyolefin emulsifier having a polar part. Cosmetic application, especially care and making up of keratin materials.

### REFERENCE TO PRIOR APPLICATIONS

This application claims priority to U.S. provisional application 60/712,425 filed Aug. 31, 2005, and to French patent application 0552601 filed Aug. 30, 2005, both incorporated herein by reference.

### FIELD OF THE INVENTION

The invention relates to a water-in-oil emulsion comprising a urea derivative and a polyolefin emulsifier having a polar part, and the use of the emulsion in the cosmetic or dermatological fields.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

Human skin contains two compartments, namely a superficial compartment, the epidermis, and a deep compartment, the dermis. Natural human epidermis is mainly composed of three types of cell which are the keratinocytes, which are in the great majority, the melanocytes and the Langerhans' cells.

Each of these cell types contributes, through its specific functions, to the essential role played in the body by the skin. In particular, the keratinocytes undergo a process of continuous and oriented maturation which, keratinocytes being in the basal layer of the epidermis, results in the formation of corneocytes, which are totally keratinized dead cells consisting of keratinocytes at the terminal stage of their differentiation. This process of differentiation makes it possible to arrive at the formation of lipids organized into a double layer in the stratum corneum. It also makes it possible to produce the constituents of the NMF (Natural Moisturizing Factor) composed of small water-soluble molecules with a high hygroscopic power playing the role of moisturizer. The NMFs additionally act as plasticizers, and thus contribute to the suppleness of the skin. The stratum corneum thus constituted plays a vital role in the barrier function and moisturization.

It is known that the skin has a tendency to become dry because of environmental factors (pollution, wind, cold, conditioned air), psychological factors (fatigue, stress) or hormonal factors (menopause). Now, it is important that the skin is well moisturized and is not subjected to loss of water which risks causing withering and drying of the skin.

Accordingly, it is common practice to incorporate into cosmetic compositions humectants, which are hygroscopic substances which cause remoisturization of the skin by capturing atmospheric water and by retaining water in the skin. Examples of these moisturizers are the constituents of the abovementioned NMF.

NMF mainly contains amino acids (65%), organic acids (21%) including pyrrolidonecarboxylic acid, ions (8%), urea (4%) and sugars (2%).

Thus, it is also known to use hydroxyl acids and their salts, and in particular lactic acid and sodium lactate to improve the suppleness and the elasticity of the skin (M. Rieger, Cosmetics & Toiletries, 1992, vol. 107, pp. 89-90). Urea has also been used to this end (FR-2 181 659). Moreover, mixtures of constituents of NMF, which can be used in the cosmetic field, are commercially available, such as the products sold under the trade names Hydrasoft by the company VINCIENCE and Hydrosmyl LS4513 by the company COGNIS. Finally, some heterogeneous polysaccharides are biological precursors of sugars and can therefore be used as moisturizers.

In addition to the constituents of NMF, polyols such as propylene glycol or glycerin, and glucosaminoglycans (GAG) or mucopolysaccharides have also been used to improve the moisturization of the skin. These compounds have a high water retention capacity. Among them, sulphated GAGs and hyaluronic acid are synthesized by the keratinocytes. In addition to the solution consisting in supplying these compounds to the skin by the exogenous route, it has also been proposed to use compounds promoting their synthesis (endogenous route).

A moisturizing composition for skin and hair care comprising a hydroxyalkylurea, in particular N-(2-hydroxyethyl) urea, is also known from applications DE-A-2703185 and EP-A-1535607.

It is still nevertheless the case that the need remains to have available compositions having an improved moisturizing action which make it possible to prevent and/or combat more effectively the signs of skin drying.

### SUMMARY OF THE INVENTION

One object of the invention is therefore to make available a composition comprising a hydroxyalkylurea with an improved moisturizing action. In this regard, the inventor has accomplished this object and provided a composition comprising an aqueous phase dispersed in an oily phase, and at least one compound of the following formula (I): 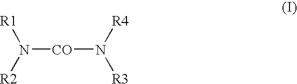
in which:
R₁, R₂, R₃ and R₄ each represent, independently of each other, a hydrogen atom, a C₁-C₄ alkyl group or a C₂-C₆ hydroxyalkyl group which may contain from 1 to 5 hydroxyl groups, where at least one of the radicals R₁
to R₄ represents a hydroxyalkyl group,
and their salts, their solvates and their isomers;
and at least one polyolefin emulsifier having a polar part and described its cosmetic application, especially for the care and making up of keratin materials.

### DETAILED DESCRIPTION OF THE PREFERRED EMBODIMENTS

The inventor has discovered that the moisturizing properties of hydroxyalkylurea derivatives may be improved by formulating these derivatives in a water-in-oil emulsion containing, as emulsifier, a polyolefin having a polar part.

In a preferred embodiment the invention relates to a composition comprising an aqueous phase dispersed in an oily phase, and at least one urea compound of the following formula (I): 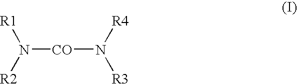
in which:
R₁, R₂, R₃ and R₄ each represent, independently of each other, a hydrogen atom, a C₁-C₄ alkyl group or a C₂-C₆ hydroxyalkyl group which may contain from 1 to 5 hydroxyl groups, where at least one of the radicals R₁ to R₄ represents a hydroxyalkyl group,
and their salts, their solvates and their isomers;
and at least one polyolefin emulsifier having a polar part.

Another subject of the invention is a (non-therapeutic) cosmetic method of treating or making up keratin materials comprising the application, to the keratin materials, of a composition as described above. The method applies in particular for the skin and the lips, in particular for the skin and dry lips.

The subject of the invention is also the cosmetic use of a composition as described above for moisturizing keratin materials, in particular the skin and the lips.

The urea compound present in the composition according to the invention is at least one compound of the following formula (I): 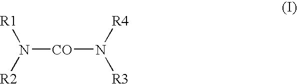
in which:
R₁, R₂, R₃ and R₄ each represent, independently of each other, a hydrogen atom, a C₁-C₄ alkyl group or a C₂-C₆ hydroxyalkyl group which may contain from 1 to 5 hydroxyl groups, where at least one of the radicals R₁ to R₄ represents a hydroxyalkyl group,
and their salts, their solvates and their isomers.

For compounds of formula (I):

Preferably R₁ denotes a C₂-C₆ hydroxyalkyl group, and R₂, R₃ and R₄ denote, independently of each other, a hydrogen atom or a C₁-C₄ alkyl group;

Preferably, R₁ denotes a C₂-C₆ hydroxyalkyl group comprising from 1 to 5 hydroxyl groups, in particular 1 hydroxyl group, and R₂, R₃and R₄ denote a hydrogen atom;

More preferably, R₁ denotes a C₂-C₄ hydroxyalkyl group comprising 1 hydroxyl group and R₂, R₃ and R₄ denote a hydrogen atom.

Among the alkyl groups, there may be mentioned methyl, ethyl, n-propyl, isopropyl, n-butyl, isobutyl and tert-butyl groups.

Among the hydroxyalkyl groups, those containing a single hydroxyl group and in particular the hydroxy-ethyl, hydroxypropyl, hydroxybutyl, hydroxypentyl and hydroxyhexyl groups, are preferred.

Among the salts, there may be mentioned the salts of inorganic acids, such as sulphuric acid, hydrochloric acid, hydrobromic acid, hydriodic acid, phosphoric acid and boric acid. There may also be mentioned the salts of organic acids which may contain one or more carboxylic, sulphonic or phosphonic acid groups. They may be linear, branched or cyclic aliphatic acids or aromatic acids. These acids may additionally contain one or more heteroatoms chosen from O and N, for example in the form of hydroxyl groups. There may be mentioned in particular propionic acid, acetic acid, terephthalic acid, citric acid and tartaric acid.

The expression solvate is understood to mean a stoichiometric mixture of the said compound of formula (I) with one or more molecules of water or of organic solvent, such a mixture being derived from the synthesis of the compound of formula (I).

As preferred compounds of formula (I), there may be mentioned N-(2-hydroxyethyl)urea; N-(2-hydroxypropyl)-urea, N-(3-hydroxypropyl)urea; N-(2,3-dihydroxypropyl)-urea; N-(2,3,4,5,6-pentahydroxyhexyl)urea; N-methyl-N-(1,3,4,5,6-pentahydroxy-2-hexyl)urea; N-methyl-N′-(1-hydroxy-2-methyl-2-propyl)urea; N-(1-hydroxy-2-methyl-2-propyl)urea; N-(1,3-dihydroxy-2-propyl)urea; N-(trishydroxymethylmethyl)urea; N-ethyl-N′-(2-hydroxyethyl)urea; N,N-bis(2-hydroxyethyl)urea; N,N′-bis(2-hydroxyethyl)urea; N,N-bis(2-hydroxypropyl)urea; N,N′-bis(2-hydroxypropyl)urea; N,N-bis(2-hydroxyethyl)-N′-propylurea; N,N-bis(2-hydroxypropyl)-N′-(2-hydroxy-ethyl)urea; N-tert-butyl-N′-(2-(hydroxyethyl)-N′-(2-(hydroxypropyl)urea; N-(1,3-dihydroxy-2-propyl)-N′-(2-hydroxyethyl)urea; N,N-bis(2-hydroxyethyl)-N′,N′-dimethylurea; N,N,N′,N′-tetrakis(2-hydroxyethyl)urea; N′,N′-bis(2-hydroxyethyl)-N′,N′-bis(2-hydroxypropyl)-urea; and mixtures thereof. Preferably, the compound of formula (I) is N-(2-hydroxyethyl)urea.

The compounds of formula (I) are known compounds which are described in particular in application DE-A-2703185. Among these, N-(2-hydroxyethyl)urea is additionally commercially available in the form of a mixture at 50% by weight in water from the company NATIONAL STARCH under the trade name Hydrovance®.

The compound of formula (I) may preferably be present in the emulsion according to the invention in an amount ranging from 1% to 50% by weight, relative to the total weight of the composition, more preferably ranging from 2% to 25% by weight, and even more preferably ranging from 2% to 20% by weight.

Preferred polyolefins having a polar part which can be used in the invention include those that are known in other fields. Thus, they are described for example in the documents U.S. Pat. No. 5,129,972 and U.S. Pat. No. 4,919,179, as stabilizers of explosive emulsions. Moreover, these compounds are known as stabilizers of fertilizer compositions (see the documents U.S. Pat. No. 5,518,517 and U.S. Pat. No. 5,858,055) in order to obtain controlled release of the fertilizer substances.

The polyolefins having a polar part or polar parts used in the composition of the invention generally have a polyolefin apolar part and at least one polar part. They may have a block or comb type structure.

The polyolefin apolar part preferably comprises at least 40 carbon atoms and more preferably 60 to 700 carbon atoms. This apolar part may be chosen from polyolefins such as oligomers, polymers and/or copolymers of ethylene, propylene, 1-butene, isobutene, 1-pentene, 2-methyl-1-butene, 3-methyl-1-butene, 1-hexene, 1-heptene, 1-octene, 1-decene, 1-undecene, 1-dodecene, 1-tridecene, 1-tetradecene, 1-pentadecene, 1-hexadecene, 1-heptadecene and 1-octadecene. These polyolefins are hydrogenated or nonhydrogenated.

Moreover, the polyolefins having a polar part used in the emulsion of the invention contain at least one polar part. This polar part confers amphiphilic properties on them. Thus, these polyolefins having a polar part lower the interfacial (water/oil) tension by at least 10 mN/m when they are present at a concentration of 0.01% by weight relative to the total weight of the oily phase. For example, the polyolef in with a succinic end marketed under the name Lubrizol 2724 by the company Lubrizol, at a concentration of 0.01% by weight relative to the total weight of the oily phase, lowers the interfacial tension by 15 mN/m at the interface of an aqueous phase consisting of an aqueous solution at 1% MgSO₄, and of an oily phase containing a mixture of oils (isohexadecane/-hydrogenated polyisobutene/volatile silicone in a ratio of 8/6/4).

The polar part of the polyolefins having a polar part of the invention may be anionic, cationic, nonionic, zwitterionic or amphoteric. It is made up, for example, of polyalkylene glycols or polyalkylene imines, or alternatively of carboxylic acids or dicarboxylic acids, of their anhydrides or of their derivatives such as their esters, their amides and their salts, and mixtures thereof. The polyolefins having a carboxylic acid polar part may be derived for example from the reaction between a polyolefin and at least one carboxylic acid or carboxylic anhydride optionally completely or partially salified, chosen from the group comprising succinic acid or anhydride, maleic acid, maleic anhydride, fumaric acid, itaconic acid, citraconic acid (or methylmaleic acid), mesaconic acid (or methylfumaric acid), aconitic acid, their ester or amide derivatives, and mixtures thereof.

Preferably, the polar part is succinic acid or anhydride, esters or amides of succinic acid or anhydride, alkali or alkaline-earth metal salts or organic salts of succinic acid or anhydride, or partial salts of the monoesters or monoamides of succinic acid or anhydride, or alternatively of a polyoxyethylene.

The polyolefins having a polyoxyethylene polar part may be chosen for example from polyisoprene-polyoxyethylene diblock polymers, poly(ethylene-co-propylene)-polyoxy-ethylene polymers and mixtures thereof. These polymers are described in the publication by Allgaier, Poppe, Willner, Richter (Macromolecules, 1997, vol. 30, p. 1582-1586).

The polyolefins having a succinic acid or anhydride polar part may be chosen in particular from the polyolefin derivatives of succinic acid or anhydride described in patents U.S. Pat. No. 4,234,435, U.S. Pat. No. 4,708,753, U.S. Pat. No. 5,129,972, U.S. Pat No. 4,931,110, GB-A-2,156,799, U.S. Pat. No. 4,877,756 and U.S. Pat. No. 4,919,179. The polyolefin part may consist for example of hydrogenated or non-hydrogenated polyisobutylene having a molecular weight ranging from 400 to 5000. In the polyisobutylene with a succinic end thus obtained, the succinic part may be optionally modified, that is to say esterified, amidated or in the form of a salt. It may be modified with alcohols, amines, alkanolamines or polyols, or may be in the form of salts of an alkali or alkaline-earth metal, of ammonium or alternatively of an organic base such as the salts of diethanolamine, triethanolamine or diethylethanolamine. The polyolefins with an esterified or amidated succinic end are products of the reaction of (a) a polyolefin with a succinic end, and of (b) an amine or an alcohol, to form an amide or an ester. The term “amine” used here comprises all types of amines including alkanolamines. They may be for example primary, secondary or tertiary monoamines, it being possible for these amines to be aliphatic, cyclo-aliphatic, aromatic, heterocyclic, saturated or unsaturated. By way of example of alkanolamines, there may be mentioned diethylethanolamine and triethanol-amine.

Moreover, the alcohols may be mono- or polyalcohols. The monoalcohols comprise the primary, secondary or tertiary aliphatic alcohols, and phenols. The polyalcohols may be chosen for example from aliphatic, cycloaliphatic, aromatic and heterocyclic polyalcohols. By way of examples of polyalcohol, glycerol may be mentioned.

The polyolefins with a modified (esterified or amidated) succinic end and their method of preparation are described in particular in the document U.S. Pat. No. 4,708,753. Polyolefins with an esterified succinic end are preferably used.

As polyolefins with a succinic end, there may be mentioned in particular polyisobutylenes with an esterified succinic end, in particular esterified with diethanolamine, and their salts, in particular the diethanolamine salts, such as the products marketed under the names Lubrizol® 2724, Lubrizol® 2722 and Lubrizol® 5603 by the company Lubrizol.

Another example of polyolefin having a polar part which can be used in the invention is the product of the reaction of maleic anhydride with polyisobutylene, such as the products marketed under the names Glissopal (Glissopal 2300, 1300 and 1000) (INCI name: polyisobutene) by the company BASF.

A particularly preferred polyolefin having a polar part is a product of the reaction of polyisobutenylsuccinic anhydride with diethylethanolamine, thus forming a diethylethanolamine salt of 2-(N,N-diethyl)aminoethyl polybutene succinate. This product is sold for example under the name Lubrizol® 5603 by the company Lubrizol, and may be represented by the following formula: 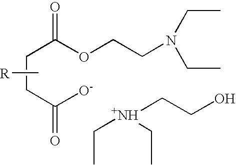
in which R represents a polyisobutenyl group, in particular having a weight-average molecular mass of 1000. This product has the INCI name: Hydroxyethyldiethonium Polyisobutenyl Triethylaminosuccinate (and) Diethyl ethanolamine.

Another particularly preferred polyolefin having a polar part is an ester of diethanolaminoethyl polyisobutenyl succinate and triethanolamine. This product is sold for example under the name Chemccinate® 2000 by the company Chemron.

By way of polyolef in having a polar part, it is also possible to use a glyceryl polyisobutenyl succinate ester, in particular that sold under the name Chemccinate® 1000 AF by the company Chemron.

Preferably, the polyolefin(s) having a polar part, as defined above, are present in the emulsion according to the invention in an amount ranging from 0.01% to 10% by weight, preferably from 0.1% to 7% by weight, and better still from 0.2% to 5% by weight relative to the total weight of the composition.

The composition according to the invention contains an aqueous phase dispersed in an oily phase, and preferably is a water-in-oil emulsion.

According to a preferred embodiment of the invention, the oily phase of the composition according to the invention contains at least one oil. The expression “oil” is understood to mean a fatty substance that is liquid at room temperature (25° C.).

As oils which can be used in the composition of the invention, there may be mentioned for example:

hydrocarbon oils of animal origin, such as perhydroqsualene (or squalane);

hydrocarbon oils of plant origin, such as liquid triglycerides of fatty acids containing from 4 to 10 carbon atoms such as triglycerides of heptanoic or octanoic acids or alternatively for example sunflower, maize, soybean, gourd, grapeseed, sesame, hazelnut, apricot, macadamia, arara, coriander, castor and avocado oils, triglycerides of caprylic and capric acids such as those sold by the company Stearineries Dubois or those sold under the names Miglyol 810, 812 and 818 by the company Dynamit Nobel, jojoba oil, shea butter oil;

synthetic esters and ethers, in particular of fatty acids, such as the oils of formulae R¹COOR² and R¹OR² in which R¹ represents the residue of a fatty acid containing from 8 to 29 carbon atoms, and R² represents a branched or unbranched hydrocarbon chain containing from 3 to 30 carbon atoms, such as for example Purcellin oil, isononyl isononanoate, isopropyl myristate, 2-ethylhexyl palmitate, 2-octyldodecyl stearate, 2-octyldodecyl erucate, isostearyl iso-stearate; hydroxylated esters such as isostearyl lactate, octyl hydroxystearate, octyldodecyl hydroxystearate, diisostearyl malate, triisocetyl citrate, heptanoates, octanoates and decanoates of fatty alcohols; polyol esters, such as propylene glycol dioctanoate, neopentyl glycol diheptanoate and diethylene glycol diisononanoate; pentaerythritol esters such as pentaerythrityl tetraisostearate; the lipophilic derivatives of amino acids, such as isopropyl lauroyl sarcosinate (INCI name: Isopropyl Lauroyl Sarcosinate) marketed under the name Eldew SL 205 by the company Ajinomoto;

linear or branched hydrocarbons, of mineral or synthetic origin, such as mineral oils (mixture of hydrocarbon atoms derived from petroleum; INCI name: Mineral Oil), volatile or non-volatile paraffin oils, and derivatives thereof, liquid paraffin, polydecenes, isohexadecane, isododecane, hydrogenated isoparaffin such as Parleam® oil marketed by the company NOF Corporation (INCI name: Hydrogenated Polyisobutene);

fatty alcohols having from 8 to 26 carbon atoms, such as cetyl alcohol, stearyl alcohol and a mixture thereof (cetearyl alcohol), octyldodecanol, 2-butyloctanol, 2-hexyldecanol, 2-undecylpentadecanol or oleyl alcohol;

partially hydrocarbon-based and/or silicone-based fluorinated oils such as those described in the document JP-A-2-295912;

silicone oils such as volatile or non-volatile polymethylsiloxanes (PDMS) with a linear or cyclic silicone-based chain, which are liquid or pasty at room temperature, in particular cyclopolydimethylsiloxanes (cyclomethicones) such as cyclopentasiloxane and cyclo-hexadimethylsiloxane; polydimethylsiloxanes containing alkyl, alkoxy or phenyl groups which are pendant or at the silicone chain end, groups having from 2 to 24 carbon atoms; phenylated silicones such as phenyl-trimethicones, phenyldimethicones, phenyltrimethyl-siloxydiphenylsiloxanes, diphenyldimethicones, diphenylmethyldiphenyltrisiloxanes, 2-phenylethyl-trimethylsiloxysilicates and polymethylphenylsiloxanes;

mixtures thereof.

According to a preferred embodiment of the invention, the composition contains at least one oil chosen from linear or branched hydrocarbons of mineral or synthetic origin, such as Parleam oil.

The oily phase of the composition according to the invention may comprise other fatty substances, chosen in particular from fatty acids comprising from 8 to 30 carbon atoms, such as stearic acid, lauric acid, palmitic acid; gums such as silicone gums (dimethiconol); waxes; pasty fatty substances; and mixtures thereof.

The oily phase comprising all the fatty substances and the lipid adjuvants which may be present (for example fillers, active agents and the like) may preferably be present in the composition according to the invention in an amount generally ranging from 5 to 80%, preferably from 10 to 60% by weight, and even better from 10 to 30% by weight relative to the total weight of the composition.

The aqueous phase of the composition of the invention may preferably be present in an amount ranging from 20 to 95% by weight, relative to the total weight of the composition, preferably ranging from 50 to 92% by weight, and even better ranging from 60 to 90% by weight. It contains at least water, in particular in an amount ranging from 40% to 90% by weight, relative to the total weight of the composition, and preferably ranging from 50% to 85% by weight. It may additionally contain water, one or more solvents which are miscible with water or at least partly miscible with water at room temperature.

The expression “room temperature” should be understood to mean a temperature of about 25° C., at normal atmospheric pressure.

As water-miscible solvents, there may be mentioned in particular lower monoalcohols having from 1 to 5 carbon atoms, such as ethanol and isopropanol, glycols having from 2 to 8 carbon atoms such as ethylene glycol, propylene glycol, 1,3-butylene glycol and dipropylene glycol, C₃ and C₄ ketones and C₂ to C₄ aldehydes.

The water-miscible solvent(s) may be present in a quantity ranging from 0.1 to 30% by weight relative to the total weight of the composition.

The composition of the invention may for example be in the form of a W/O emulsion or a W/O/W multiple emulsion. This W/O emulsion may be used as it is or may be used for the preparation of a W/O/W multiple emulsion by incorporating the primary W/O emulsion into an additional external aqueous phase. Thus, the polyolefin emulsifiers having a polar part described above may also be used as emulsifiers of a W/O/W multiple emulsion.

The composition of the invention may constitute in particular a cosmetic, dermatological or pharmaceutical composition, and more particularly a cosmetic composition, intended in particular for application to keratin materials, in particular to the skin and/or the mucous membranes.

The compositions of the invention may comprise at least one colorant which for example may be present in particular in an amount of 0.01% to 40% by weight, in particular from 0.01% to 30% by weight, and in particular from 0.05% to 25% by weight, relative to the total weight of the product.

The colorants may be chosen for example from pigments, water-soluble or fat-soluble colorants, pearlescent agents, glitter and mixtures thereof.

The expression pigments should be understood to mean white or coloured, mineral or organic particles, which are insoluble in the hydrophilic liquid phase, intended to colour and/or opacify the composition. The expression pearlescent agents should be understood to mean iridescent particles which are produced in particular by certain molluscs in their shell or synthesized.

There may be mentioned, among the mineral pigments, titanium dioxide, which has been optionally surface treated, zirconium or cerium oxides, and zinc, iron (black, yellow or red) or chromium oxides, manganese violet, ultramarine blue, chromium hydrate and ferric blue, metal powders such as aluminium powder, copper powder.

Among the organic pigments, there may be mentioned carbon black, D & C type pigments, and lacquers based on carmine, barium, strontium, calcium or aluminium.

There may also be mentioned pigments with effect such as particles containing a natural or synthetic, organic or inorganic substrate, for example glass, acrylic resins, polyester, polyurethane, polyethylene terephthalate, ceramics or aluminas, the said substrate being coated or otherwise with metal substances such as aluminium, gold, silver, platinum, copper, bronze, or metal oxides such as titanium dioxide, iron oxide, chromium oxide and mixtures thereof.

The pearlescent pigments may be chosen from mica coated with titanium or bismuth oxychloride, mica-titanium coated with iron oxides, mica-titanium coated with in particular ferric blue or chromium oxide, mica-titanium coated with an organic pigment of the abovementioned type and pearlescent pigments based on bismuth oxychloride. It is also possible to use interferential pigments, in particular containing liquid or multilayer crystals. The water-soluble colorants are for example beet juice and methylene blue.

The compositions according to the invention may further comprise any or all ingredients used in the relevant fields and more especially in the cosmetic and dermatological field. These ingredients may be chosen in particular from colorants, vitamins, antioxidants, thickeners, trace elements, emollients, sequestrants, perfumes, akalinizing or acidifying agents, preservatives, antioxidants, UV-screening agents, hydrophilic or lipophilic active agents and mixtures thereof, and fillers. The quantities of these various ingredients are those used in the fields considered, and are for example from 0.01/% to 20/6 of the total weight of the composition.

The composition according to the invention may also contain active agents in the cosmetic or dermatological field. There may be mentioned in particular active agents having activity on skin ageing such as keratolytic or prodesquamating agents, for example α-hydroxy acids, β-hydroxy acids, α-keto acids, retinoids and their esters, retinol, retinoic acid and its derivatives. There may also be mentioned vitamins, such as for example vitamins C, B3 or PP, B5, E, and the derivatives of these vitamins, and in particular their esters; vitamin K and its derivatives (K1, K2 and the like); anti-free radical agents; sunscreening agents; moisturizing agents such as polyols; DHEA and its derivatives; coenzyme Q10; bleaching and depigmenting agents such as kojic acid, para-aminophenol derivatives, arbutin and derivatives thereof, and mixtures thereof.

Of course, persons skilled in the art will be careful to choose the possible compound(s) to be added to the composition according to the invention and their quantities, such that the advantageous properties intrinsically attached to the composition in accordance with the invention are not or not substantially impaired by the addition envisaged.

The composition according to the invention may be provided in any form, including in particular in the form of a cream, an ointment, a milk, a serum or a lotion.

The composition of the invention may for example be used for the care, the treatment or the making up of keratin materials (in particular of human beings), such as the skin, the lips, the hair, the eyelashes, the nails, and in particular of the skin (in particular of the face, the body, the scalp) and of the lips.

The composition according to the invention may be a care product for the skin, in particular for the face, the neck, the contour of the eye, the body, or a makeup composition, in particular a makeup product for the lips (lipstick), a foundation, a blusher, an eyeshadow, an eyeliner, a concealer product, a makeup product for the body.

Advantageously, the composition is a leave-in composition.

The composition of the invention may also be used for the care and/or treatment of the hair (for example mask for the hair).

The invention is illustrated in greater detail in the examples described below, the contents being expressed as a percentage by weight.

### EXAMPLE 1

A water-in-oil emulsion comprising the following ingredients was prepared:

Phase 1:

| | |
|---|---|
| Isohexadecane | 7% |
| Cyclopentasiloxane | 5% |
| Isododecane | 2% |
| Mixture of triethanolamine-diethanolamine | 3.5% |
| polyisobutenyl succinate and 2-ethylhexyl | |
| palmitate (Chemccinate 2000 from Chemron) | |

Phase 2:

| | |
|---|---|
| N-(2-hydroxyethyl)urea | 7.5% |
| Magnesium sulphate | 0.8% |
| Water | qs 100% |

Phase 2 is introduced with vigorous stirring into Phase 1. A fluid water-in-oil emulsion is obtained. The application of the composition to the face makes it possible to moisturize the skin in a satisfactory manner and with no sticky effect.

### COMPARATIVE EXAMPLE 2

### Not in Accordance with the Invention

An emulsion similar to that of Example 1 was prepared by replacing polyisobutenyl succinate with another emulsifier, polyglycerol-3 isostearate, which does not form part of the invention.

Phase 1:

| | |
|---|---|
| Isohexadecane | 7% |
| Cyclopentasiloxane | 5% |
| Isododecane | 2% |
| Polyglyceryl-3 isostearate | 3.5% |

Phase 2:

| | |
|---|---|
| N-(2-hydroxyethyl)urea | 7.5% |
| Magnesium sulphate | 0.8% |
| Water | qs 100% |

The emulsion is prepared in the same manner as that in Example 1.

The application of this emulsion to the skin confers a moisturizing performance that is less than that obtained with the emulsion according to the invention of Example 1.

### EXAMPLE 3

A water-in-oil emulsion comprising the following ingredients is prepared:

Phase 1:

| | |
|---|---|
| Isohexadecane | 10% |
| Cyclopentasiloxane | 5% |
| Isododecane | 2% |
| Mixture of polyisobutenyl succinate of | 3.5% |
| diethyldiethanolamine salt of 2-(N,N- | |
| diethyl)aminoethyl polybutene succinate | |
| (Lubrizol ® 5603 from Lubrizol) | |

Phase 2:

| | |
|---|---|
| N-(2-hydroxyethyl)urea | 7.5% |
| Magnesium sulphate | 0.8% |
| Water | qs 100% |

Phase 2 is introduced with vigorous stirring into Phase 1. A fluid water-in-oil emulsion is obtained. The application of the composition to the face makes it possible to moisturize the skin in a satisfactory manner and with no sticky effect.

The above written description of the invention provides a manner and process of making and using it such that any person skilled in this art is enabled to make and use the same, this enablement being provided in particular for the subject matter of the appended claims, which make up a part of the original description and including a composition comprising an aqueous phase dispersed in an oily phase, and at least one compound of the following formula (I): 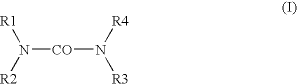
in which:
R₁, R₂, R₃ and R₄ each represent, independently of each other, a hydrogen atom, a C₁-C₄ alkyl group or a C₂-C₆ hydroxyalkyl group which may contain from 1 to 5 hydroxyl groups, where at least one of the radicals R₁ to R₄ represents a hydroxyalkyl group,
and their salts, their solvates and their isomers;
and at least one polyolefin emulsifier having a polar part.

As used herein, the phrases “selected from the group consisting of,” “chosen from,” and the like include mixtures of the specified materials. Terms such as “contain(s)” and the like as used herein are open terms meaning ‘including at least’unless otherwise specifically noted.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A composition comprising:
an aqueous phase dispersed in an oily phase;
at least one compound of formula (I): 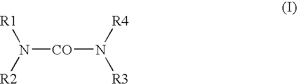
in which:
R₁, R₂, R₃ and R₄ each represent, independently of each other, a hydrogen atom, a C₁-C₄ alkyl group or a C₂-C₆ hydroxyalkyl group which may contain from 1 to 5 hydroxyl groups, where at least one of the radicals R₁ to R₄ represents a hydroxyalkyl group, and their salts and solvates; and
at least one polyolefin emulsifier having a polar part.

2. The composition according to claim 1, wherein for the compounds of formula (I) R₁ denotes a C₂-C₆ hydroxyalkyl group and R₂, R₃ and R₄ denote, independently of each other, a hydrogen atom or a C₁-C₄ alkyl group.

3. The composition according to claim 1, wherein for the compounds of formula (I) R₁ denotes a C₂-C₆ hydroxyalkyl group comprising from 1 to 5 hydroxyl groups, and R₂, R₃ and R₄ denote a hydrogen atom.

4. The composition according to claim 3, wherein R₁ denotes a C₂-C₆ hydroxyalkyl group comprising 1 hydroxyl group.

5. The composition according to claim 1, wherein for the compounds of formula (I) R₁ denotes a C₂-C₄ hydroxyalkyl group comprising 1 hydroxyl group and R₂, R₃ and R₄ denote a hydrogen atom.

6. The composition according to claim 1, wherein comprising at least one compound of formula (I) chosen from N-(2-hydroxyethyl)urea; N-(2-hydroxypropyl)urea, N-(3-hydroxypropyl)urea; N-(2,3-dihydroxypropyl)urea; N-(2,3,4,5,6-pentahydroxyhexyl)urea; N-methyl-N-(1,3,4,5,6-pentahydroxy-2-hexyl)urea; N-methyl-N′-(1-hydroxy-2-methyl-2-propyl)urea; N-(1-hydroxy-2-methyl-2-propyl)urea; N-(1,3-dihydroxy-2-propyl)urea; N-(trishydroxymethylmethyl)urea; N-ethyl-N′-(2-hydroxyethyl)urea; N,N-bis(2-hydroxyethyl)urea; N,N′-bis(2-hydroxyethyl)urea; N,N-bis(2-hydroxypropyl)urea; N,N′-bis(2-hydroxypropyl)urea; N,N-bis(2-hydroxyethyl)-N′-propylurea; N,N-bis(2-hydroxypropyl)-N′-(2-hydroxy-ethyl)urea; N-tert-butyl-N′-(2-(hydroxyethyl)-N′-(2-(hydroxypropyl)urea; N-(1,3-dihydroxy-2-propyl)-N′-(2-hydroxyethyl)urea; N,N-bis(2-hydroxyethyl)-N′,N′-dimethylurea; N,N,N′,N′-tetrakis(2-hydroxyethyl)urea; N′,N′-bis(2-hydroxyethyl)-N′,N′-bis(2-hydroxypropyl)-urea; and their salts and solvates.

7. The composition according to claim 1, comprising N-(2-hydroxyethyl)urea.

8. The composition according to claim 1, wherein the salts of the compounds of formula (I) are chosen from the salts of sulphuric acid, hydrochloric acid, hydrobromic acid, hydriodic acid, phosphoric acid, boric acid, propionic acid, acetic acid, terephthalic acid, citric acid and tartaric acid.

9. The composition according to claim 1, wherein the compound(s) of formula (I) is/are present in an amount ranging from 1% to 50% by weight, relative to the total weight of the composition.

10. The composition according to claim 1, wherein the polyolefin having a polar part contains an apolar polyolefin part comprising at least 40 carbon atoms.

11. The composition according to claim 10, wherein the apolar polyolefin part is chosen from oligomers, polymers and/or copolymers of ethylene, propylene, 1-butene, isobutene, 1-pentene, 2-methyl-1-butene, 3-methyl-1-butene, 1-hexene, 1-heptene, 1-octene, 1-decene, 1-undecene, 1-dodecene, 1-tridecene, 1-tetradecene, 1-pentadecene, 1-hexadecene, 1-heptadecene and 1-octadecene.

12. The composition according to claim 1, wherein the polar part of the polyolefin is anionic, cationic, nonionic, zwitterionic or amphoteric.

13. The composition according to claim 1, wherein the polar part of the polyolefin is chosen from polyalkylene glycols, polyalkylene imines, carboxylic acids or dicarboxylic acids, their anhydrides, esters, amides and salts, and mixtures thereof.

14. The composition according to claim 1, wherein the polar part of the polyolefin is chosen from polyoxyethylenes, succinic acid or anhydride, esters or amides of succinic acid or anhydride, alkali or alkaline-earth metal salts or organic salts of succinic acid or anhydride, and partial salts of monoesters or monoamides of succinic acid or anhydride.

15. The composition according to claim 1, wherein the polyolefin having a polar part is a polyisobutylene with an optionally modified succinic end.

16. The composition according to claim 1, wherein the polyolefin having a polar part is a polyisobutylene with an esterified succinic end.

17. The composition according to claim 1, wherein the polyolefin having a polar part is present in an amount ranging from 0.01% to 10% by weight relative to the total weight of the composition.

18. The composition according to claim 1, wherein it further comprises an oil.

19. The composition according to claim 1, wherein the oily phase is present in an amount ranging from 5 to 80% by weight, relative to the total weight of the composition.

20. The composition according to claim 1, wherein the aqueous phase is present in an amount ranging from 20 to 95% by weight relative to the total weight of the composition.

21. The composition according to claim 1, wherein the composition is in the form of a water-in-oil emulsion or a W/O/W multiple emulsion.

22. The composition according to claim 1, further comprising at least one chosen from colorants, vitamins, antioxidants, thickeners, trace elements, emollients, sequestrants, perfumes, alkalinizing or acidifying agents, preservatives, antioxidants, Uv-screening agents, hydrophilic active agents, lipophilic active agents, and fillers.

23. The composition according to claim 1, wherein said composition is a cosmetic or dermatological composition.

24. A method, comprising application to a keratin material of a composition according to claim 1.
